(19) United States
(12) Patent Application Publication
(10) Pub. No.: US 2026/0078559 A1
(43) Pub. Date: Mar. 19, 2026

(54) FLAT-PACK UTILITIES VAULT

(71) Applicant: CHANNELL COMMERCIAL CORPORATION, Temecula, CA (US)

(72) Inventors: Edward J. BURKE, Temecula, CA (US); Robert H. GWILLIM, Murrieta, CA (US)

(21) Appl. No.: 19/295,227

(22) Filed: Aug. 8, 2025

Related U.S. Application Data
(60) Provisional application No. 63/694,340, filed on Sep. 13, 2024.

(51) Int. Cl. E02D 29/12; H02G 3/08

(52) U.S. Cl. CPC E02D 29/12; H02G 3/081

(57) ABSTRACT

An underground utilities vault having side panels and a lid, the side panels each include a side wall section and an end wall section that are hinged together such that the side panels lay flat for shipping and storage and then when assembled comprise a side wall and an end wall perpendicular to one another at a hinge point, and wherein the side panels include a plurality of clamps for connecting the side panels together.

### CROSS-REFERENCE TO RELATED APPLICATION

This application claims the benefit of and priority to U.S. Provisional Application No. 63/694,340, filed on Sep. 13, 2024, the content of which is incorporated herein by reference in its entirety.

### BACKGROUND OF THE INVENTION

The present invention is directed to a vault for underground utilities having components that can lay flat for shipping and storage. Various electrical transmission lines and other equipment used for buried and underground utilities are commonly contained in enclosures that protect the underground wiring cables, fiber taps and splices, service lines, etc. from the environment. Initial construction often requires installation of such a below-ground enclosure, commonly referred to as a grade level box or vault. Later, if service is to be provided to the premises, the cover for the grade level box is removed and connections are made inside an above-ground pedestal housing mounted on the grade level box. The above-ground connections are protected from the weather but also must be protected from vandalism and tampering.

The present invention is applicable to any enclosure system or vault for storing and protecting underground or buried electrical conductors and devices from the environment and for facilitating access to them when making further connections, providing service, making new installations, and the like. The invention is applicable to electrical utilities connections normally using buried or underground lines or connections such as cable TV, data transmission lines, various types of telecommunications, optical fiber connections, commonly referred to as “fiber to the premises”, service lines, water meters, electrical power distribution, and other utilities equipment, for example.

Typically, underground utility vaults or enclosures consist of two molded halves which together form the enclosure. The two halves were joined by mechanical fasteners including nuts and bolts and perhaps rivets. After mechanically joined, the joint was then sealed with some sort of sealant. These methods of joining the halves together were time consuming, labor intensive and required an inventory of fasteners and sealants, not to mention required the use of additional tools for assembly. In addition, shipping and storage costs are high considering the size and bulkiness of vault components molded in either one or two pieces needing joined together. Consequently, a need exists for an improved enclosure or vault and a method of assembly of the two halves together that eliminates the drawbacks of previous enclosures and methods of assembly.

### SUMMARY

The vault of the present invention consists of side panels and a lid or cover and possibly a floor. The side panels include side and end sections that are hinged or hooked together such that they lay flat for shipping and storage and then when assembled comprise a side wall and an end wall perpendicular to one another at the hinge or hook point. For a rectangular vault the end and side sections would be of different lengths such that two side panels would comprise the vault when assembled on site.

The side panels have a recess along a top wall for receipt of the lid thereby allowing for the lid to transfer any load put upon the lid to the inner side and end walls of the vault. The lid can be formed by a sheet molding process for composite materials or other molding process for plastic lids. Alternatively, the lid can be metal or concrete as is known in the industry for a particular application. To retain the lid on the vault, the lid can include a hook on a bottom surface at one end for receipt within a recess in a side or end wall and a latch on the bottom surface at an opposite end having a spring loaded latch for receipt in a recess in an opposite end or side wall.

The two side panels that make up the vault are connected to one another with interlocking hooks and/or over center clamps located at one end of the panel which engage an opposite end of the adjacent panel to allow for toolless assembly of the vault. Each side panel is typically molded with intersecting horizontal and vertical ribs forming a grid pattern on an outside surface for structural rigidity of the vault.

### BRIEF DESCRIPTION OF THE DRAWINGS

FIG. 1 is a perspective view of one embodiment of an underground utilities enclosure according to principles of this invention;

FIG. 2 is a top view of the enclosure of FIG. 1;

FIG. 3 is a top view of on side section of the enclosure of FIG. 1;

FIG. 4 is a detail view of a clamp in an open position within the enclosure;

FIG. 5 is a detail view of the clamp of FIG. 4 in a closed position; and

FIG. 6 is a cross-section view of the enclosure of FIG. 1.

### DETAILED DESCRIPTION

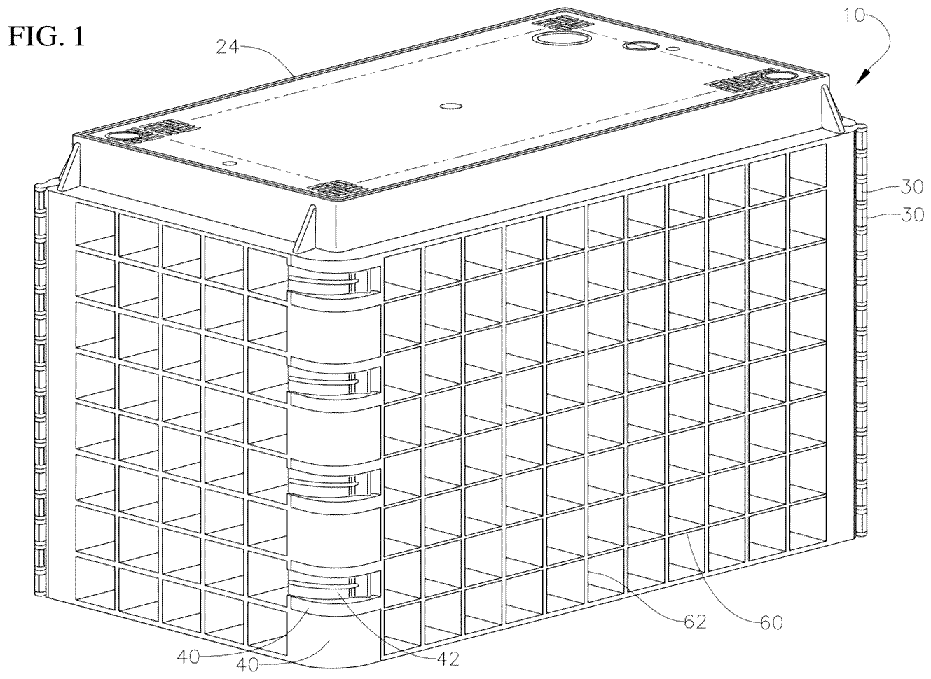

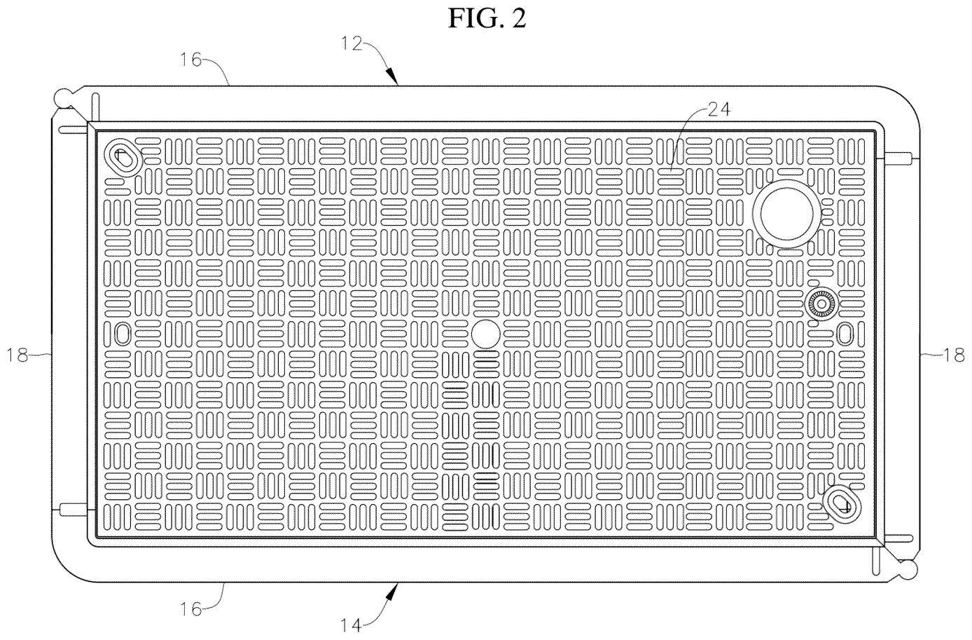

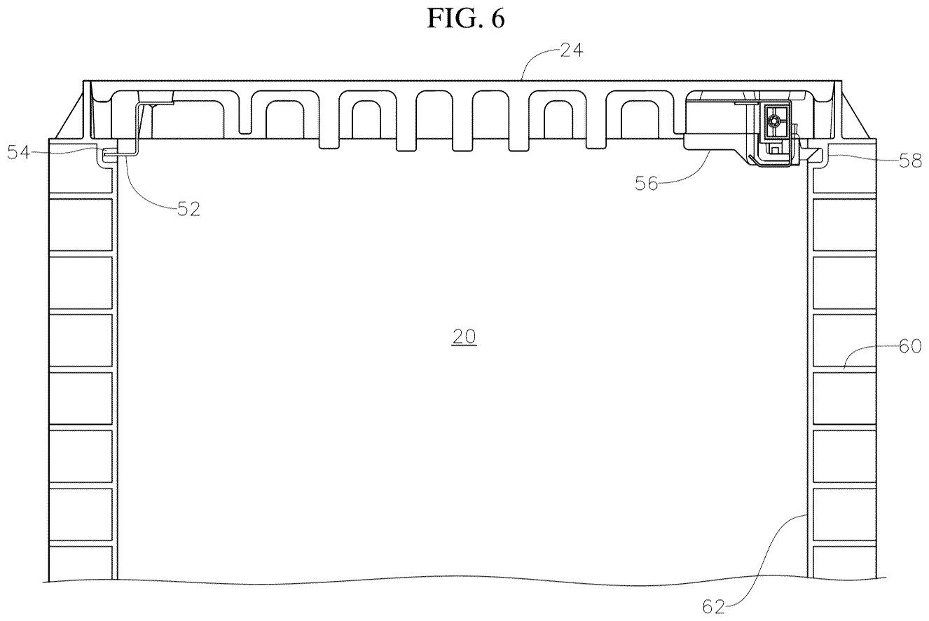

FIGS. 1-3 illustrate one embodiment of an underground utilities enclosure or vault 10 according to principles of this invention. The underground vault also is also referred to as a grade level box. The box is preferably made of a polymer, typically a hard plastic from a plastic molding process in two halves 12, 14. The grade level box is generally rectangular in configuration, having elongated parallel side walls 16 and shorter parallel end walls 18. The side and end walls enclose a hollow interior region 20 (FIG. 6) within the box. The grade level box has an open bottom and an open top. In use, the grade level box is placed below ground level to contain underground connections such as utility cables or conduits, data transmission lines, service lines, optical fiber cables and other underground utility devices, lines, or cables. These are referred to generally herein as utility connections. The connections go into the hollow interior of the grade level box through the bottom opening of the box. In use, the box is placed in the ground, so its top is generally parallel with the ground level. The grade level box has a rim 22 spaced below the top opening and the rim extends around the inside walls of the box to support a cover plate or lid 24. Optionally a floor (not shown) could be incorporated into the enclosure for certain applications.

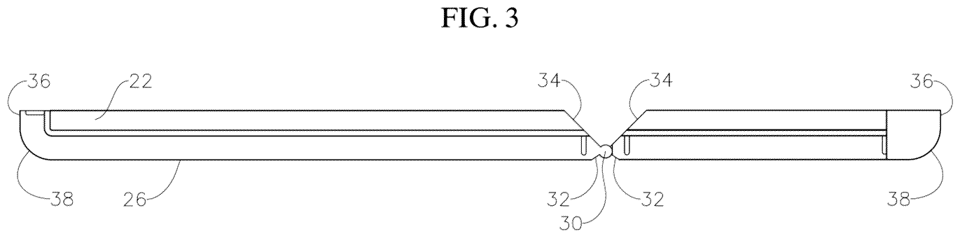

As shown in FIG. 3, each half (only half 12 is shown), of the two halves of the vault comprise a side wall portion 26 and an end wall portion 28 which each are molded with cooperating hinge portions 30 along adjacent edges 32 so that for shipping and storage each half 12, 14 can lay flat and be stacked upon one another. Side wall and end wall portions 26, 28 each have an angled edge 34 so that when assembled the angled edges engage one another to that the side wall and end wall portions are perpendicular to one another and form the side and end of the enclosure. An edge 36 of each of the side wall and end wall portions opposite edge 32 is rounded 38 along an outer surface and is sawtooth 40 in configuration so that edge 36 of each of the side wall and end wall portions engage one another when assembled. Each tooth of the sawtooth configuration of edge 36 of each side wall portion 26 contains a hook or over-center clamp 42 for connecting the halves 12, 14 of the enclosure together when assembled. It is to be understood that the clamp system could be positioned on the end wall portions as well for securing the halves together.

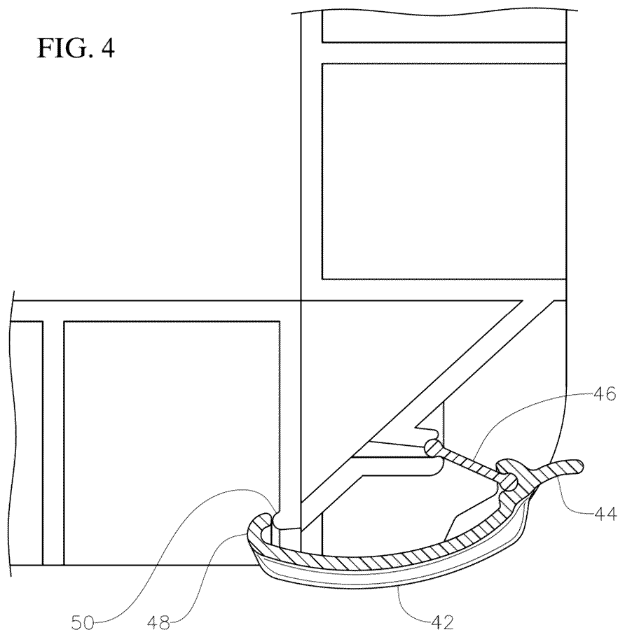

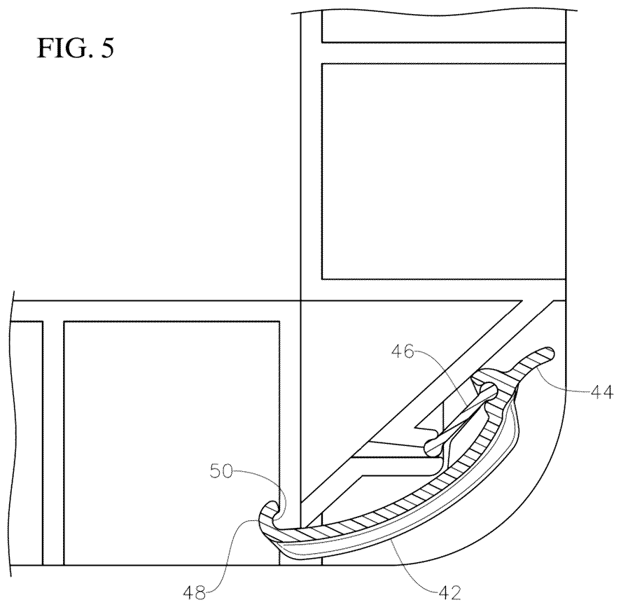

As illustrated in FIGS. 4 and 5, clamp 42 includes a tab portion 44 which is connected to a link 46 and a hook portion 48 that engages a ledge 50 of end wall portion of half 14. Link 46 is connected on an opposite end to the side wall portion so that it can rotate with respect to the tab portion and the side wall portion during opening and closing of the clamp to engage and disengage the ledge 50. The connection of the link to the tab portion and the side wall portion is by a ball and socket configuration, with the ball and socket being on either of the components. It is illustrated with the link having the ball portions. The clamp is operated manually by pushing or lifting the tab to engage or disengage the hook portion with the ledge.

As indicated herein, the vault of the present invention consists of side panels and a lid or cover and possibly a floor. The side panels include side and end sections that are hinged or hooked together such that they lay flat for shipping and storage and then when assembled comprise a side wall and an end wall perpendicular to one another at the hinge or hook point. For a rectangular vault the end and side sections would be of different lengths such that two side panels would comprise the vault when assembled on site.

The side panels have a recess along a top wall for receipt of the lid thereby allowing for the lid to transfer any load put upon the lid to the inner side and end walls of the vault. The lid can be formed by a sheet molding process for composite materials or other molding process for plastic lids. Alternatively, the lid can be metal or concrete as is known in the industry for a particular application. As shown in FIG. 6, to retain the lid 24 on the vault, the lid can include a hook 52 on a bottom surface at one end for receipt within a recess 54 in a side or end wall and a latch 56 on the bottom surface at an opposite end which is spring loaded for receipt in a recess 58 in an opposite end or side wall.

The two side panels that make up the vault are connected to one another with interlocking hooks and/or over center clamps located at one end of the panel which engage an opposite end of the adjacent panel to allow for toolless assembly of the vault. Each side panel is typically molded with intersecting horizontal ribs 60 and vertical ribs 62 forming a grid pattern on an outside surface for structural rigidity of the vault.

Although the present invention has been described and illustrated herein with respect to an embodiment and method, however it is to be understood that changes and modifications can be made therein which are within the full intended scope of the invention as hereinafter claimed.

What is claimed is:

1. An underground utilities vault comprising:
side panels; and
a lid;
wherein the side panels each include a side section and an end section that are hinged together such that the side panels lay flat for shipping and storage and then when assembled comprise a side wall and an end wall perpendicular to one another at a hinge point; and
wherein the side panels include a plurality of clamps for connecting the side panels together.

2. The vault of claim 1, wherein the side section and the end section each have an angled edge so that when assembled the angled edges engage one another.

3. The vault of claim 2, wherein an edge of each of the side section and the end section is sawtooth in configuration so that the edge of each of the side section and the end section engage one another when assembled.

4. The vault of claim 3, wherein the sawtooth configuration of the edge of the side section contains a clamp for connecting the side section to the end section.

5. The vault of claim 4, wherein the clamp includes a tab portion and a hook portion that engages a ledge on the end section.

6. The vault of claim 5, wherein the tab portion is connected to a link.

7. The vault of claim 6, wherein the link is connected on an opposite end to the side section so that it can rotate with respect to the tab portion and the side section during opening and closing of the clamp to engage and disengage the ledge.

8. The vault of claim 7, wherein the connection of the link to the tab portion and the side section is a ball and socket.

9. A utilities enclosure comprising:
a grade level vault adapted for installation below ground and having an upper opening facing an interior region for containing at least a below-ground utility service;
the grade level vault is formed in two halves comprising a first half and a second half, wherein each of the first half and the second half have a side wall section and an end wall section hinged together and a plurality of clamps for connecting the two halves together.

10. The enclosure of claim 9, wherein the side wall section and the end wall section each have an angled edge so that when assembled the angled edges engage one another.

11. The enclosure of claim 10, wherein an edge of each of the side wall section and the end wall section is sawtooth in configuration so that the edge of each of the side wall section and the end wall section engage one another when assembled.

12. The enclosure of claim 11, wherein the sawtooth configuration of the edge of the side wall section contains the clamps for connecting the side wall section to the end wall section.

13. The enclosure of claim 12, wherein the clamp includes a tab portion and a hook portion that engages a ledge on the end wall section.

14. The enclosure of claim 13, wherein the tab portion is connected to a link.

15. The enclosure of claim 14, wherein the link is connected on an opposite end to the side wall section so that the link can rotate with respect to the tab portion and the side wall section during opening and closing of the clamp to engage and disengage the ledge.

16. The enclosure of claim 15, wherein the connection of the link to the tab portion and the side wall section is a ball and socket.
